(19) United States
(12) Patent Application Publication
(10) Pub. No.: US 2019/0025448 A1
(43) Pub. Date: Jan. 24, 2019

(54) HOSE ASSEMBLY FOR UNDERWATER USE

(71) Applicant: Siemens Aktiengesellschaft, München (DE)

(72) Inventors: Michael McLoughlin, Ulverston (GB); David Michael Tucker, Millom (GB)

(73) Assignee: Siemens Aktiengesellschaft, Munich (DE)

(21) Appl. No.: 16/068,706

(22) PCT Filed: Jan. 5, 2017
(86) PCT No.: PCT/EP2017/050227

§ 371 Date: Jul. 9, 2018

(30) Foreign Application Priority Data
Jan. 12, 2016 (EP) 16150889.0

(51) Int. Cl. G01V 1/20; G01V 1/22; G02B 6/44

(52) U.S. Cl. CPC G01V 1/201; G01V 2001/204; G02B 6/4434; G01V 1/226

(57) ABSTRACT

A hose assembly for use underwater or in a wet or severe environment which includes a hose having an interior space and extending in a longitudinal direction. A first termination assembly terminates the hose at a first end and a second termination assembly terminates the hose at a second end. A signal carrier is disposed in the interior space of the hose and extends between the first and second termination assemblies. A strength member is disposed in the interior space of the hose.

### CROSS REFERENCE TO RELATED APPLICATIONS

This application is the US National Stage of International Application No. PCT/EP2017/050227 filed Jan. 5, 2017, and claims the benefit thereof. The International Application claims the benefit of European Application No. EP16150889 filed Jan. 12, 2016. All of the applications are incorporated by reference herein in their entirety.

### FIELD OF THE INVENTION

The present invention relates to a hose assembly for use underwater or in a wet or severe environment and to a subsea cable harness comprising such subsea hose assembly.

### BACKGROUND

Several applications are known in which connections need to be provided underwater, such as electrical connections and/or optical connections. Examples include a subsea installation for the production of hydrocarbons from a subsea well, in which different components of the subsea installation may need to be connected for power transfer and/or data communication. Such connections may for example comprise a connection from a topside installation, such as a floating or fixed platform, or from an onshore site to a subsea component, for example by means of an umbilical or a subsea cable. Other connections include electrical connections between different type of subsea equipment such as a connection between a subsea transformer and subsea switchgear, a data connection between different control modules or between a hub and a satellite well. In some configurations a data connection may need to be provided over short distances, such as between different components installed at a subsea well, or over increased distances, for example between two subsea wells that are more than 1 km apart. For such purpose, an optical data connection may be beneficial, in particular when making use of an Ethernet data connection.

For providing an underwater connection, subsea cables in the form of oil filled hoses are known. Such an oil filled hose comprises for example a hose in which one or more electrical conductors are disposed and that is filled with oil. Due to the flexibility of the hose, the pressure prevailing in the ambient subsea environment is transferred to the oil filling the hose. By means of such oil filled hoses, reliable underwater connections can be achieved in an economical way.

Due to the flexibility of the hose required to perform pressure compensation, the length of the hose can also change significantly due to expansion and contraction, which can be caused by several effects. As an example, during the oil filling process, the hose can contract up to 3% in length. The hose will also experience thermal expansion and contraction, and will furthermore expand upon application of mechanical force.

From the document U.S. Pat. No. 4,150,862, it is known to make use of reinforced hoses that make use of longitudinal strength members, such as nylon and Aramid fibers that are embedded in the wall of the hose. Although the strength of the hose can be improved significantly, so that it is capable of bearing the loads associated with a towed array for which it is used in the above mentioned document, such hose still experiences a significant change in a length upon application of a pulling force or for any of the other above outlined reasons. This is particularly problematic when using such hose for providing an optical connection by means of an optical fiber. Expansion and contraction may cause tension on such fiber and may lead to signal loss or signal failure.

To overcome these problems, a relatively large overlength of the optical fiber is placed in the oil filled hose to accommodate any expansion and change in length. In such configuration, the fiber is free to move within the hose. Such unrestricted and unpredictable movement, for example during assembly, transport and operation, may lead to a situation in which the fiber is bent more than the allowable bend radius. This may result in respective signal loss of a signal transported by the fiber. Accordingly, the reliability of establishing a connection can suffer in these configurations.

A further solution is the use of an additional fiber management system to compensate for length changes of the hose. This results an increase in complexity and cost for such subsea cable.

Accordingly, it is desirable to provide a more reliable connection in a subsea environment. Furthermore it is desirable to provide such connection in a cost efficient way. Furthermore, the complexity of such subsea cable should be kept low.

### SUMMARY

Accordingly there is a need to mitigate at least one of the problems mentioned above and to improve connections in a subsea environment.

This need is met by the features of the independent claims. The dependent claims described embodiments of the invention.

According to an embodiment of the invention, a hose assembly for use underwater or in a wet or severe environment is provided. The hose assembly comprises a hose having an interior space and extending in a longitudinal direction. It further comprises at first termination assembly terminating the hose at a first end and a second termination assembly terminating the hose at a second end. A signal carrier is disposed in the interior space of the hose and extends between the first and second termination assemblies. Furthermore, a strength member is disposed in the interior space of the hose. The strength member is mounted to the first termination assembly and to the second termination assembly and extends between the first termination assembly and the second termination assembly through the interior space of the hose. The strength member is configured to at least partially bear tensile stresses applied to the hose assembly.

By means of such strength member, a stretching or elongation of the hose assembly upon application of tensile stresses may be reduced significantly. Preferably, the strength member bears the full tensile stress applied to the hose assembly In particular, since the strength member bears at least part of or the full tensile stress applied to the hose assembly, the signal carrier will experience only low or almost no tensile stress, thereby enhancing the protection of the signal carrier. The strength member may be configured to counteract an expansion of the hose in the longitudinal direction. In particular, it may be configured to bear or absorb at least part of the load applied to the hose assembly in longitudinal direction, advantageously the full load applied in longitudinal direction. Accordingly, by means of the strength member, such applied load is not transferred to the hose or to the signal carrier.

Even further, since the strength member is disposed in the interior space of the hose, no additional risk of a snag by a remotely operated vehicle (ROV) or another external snag is generated, whereas such risk might be present with an external strength member. A part of the ROV may for example be caught by an external strength member and may cause substantial stresses on the hose and signal carrier.

In an embodiment, the strength member comprises a metal cable, in particular a steel cable, or a strand of a carbon composite material. Preferably, the strength member is made of a material that experiences relatively little stretch upon application of considerable tensile forces.

Accordingly, even if substantial tensile stress is applied to the hose assembly, for example when an ROV (remotely operated vehicle) accidentally gets caught by the cable, the expansion of the hose assembly is relatively low since the load is taken up by the strength member. Tensile stress on the signal carrier may thus be avoided.

In an embodiment, the signal carrier comprises at least one optical fiber. Preferably, the signal carrier comprises an optical fiber ribbon, or an optical fiber strand. By means of the hose assembly, a fiber optical cable for subsea use may thus be provided which is reliable and cost efficient to produce. In particular, there is no substantial additional length of the optical fiber required to prevent the occurrence of tensile stresses in the optical fiber. Accordingly, problems related to excessive bending and signal loss in the optical fiber may be prevented. Even further, no additional fiber management unit is required in the hose assembly for compensating an expansion of the hose.

The interior space of the hose may be filled with a substantially incompressible medium. In particular, the interior space of the hose may be filled with a liquid or a gel. As an example, it may be filled with a dielectric liquid such as oil, in particular silicone oil.

In an embodiment, the hose assembly further comprises a protection tube disposed in the interior space of the hose. The signal carrier extends inside the protection tube. Accordingly, the signal carrier can be provided with mechanical protection from the strength member. As an example, when the hose assembly is bent, the strength member may physically get into contact with the signal carrier since they may both be loosely disposed inside the hose. The protection tube around the signal carrier may prevent damage to the signal carrier in such situations.

The protection tube may be made of a plastic material, in particular a polymer material. Examples of such material are a nylon tube, a polypropylene tube or any other suitable plastic material. Other materials may also be used.

The protection tube may exhibit flexibility to allow the hose assembly to be bent. The protection tube may comprise a plurality of circumferential grooves to adjust the flexibility of the protection tube. In some embodiments, the protection tube may be a segmented tube having plural segments disposed in series.

In some embodiments, the protection tube may be configured to limit the bend radius of the signal carrier at the position at which the signal carrier is passed through the respective termination assembly. In certain configurations, the protection tube may be configured to have a predefined limited bend radius.

In an embodiment, the protection tube has at least one opening, and advantageously has plural openings, to allow a flow of medium that is present in the interior space of the hose into and out of the protection tube. Accordingly, the interior of the protection tube can be pressure compensated in a relatively simple and efficient way.

The protection tube may for example be provided with one or more slits, it may in particular be a split protection tube. In other configurations, plural holes may be provided in the protection tube, it may in particular be a perforated protection tube to allow the exchange of medium.

In an embodiment, the first and/or second termination assembly comprises a through hole through which the protection tube and the signal carrier extend. The respective termination assembly may comprise a respective termination block in which such through hole is provided and through which the protection tube is led out of the hose.

In an embodiment, the strength member is configured so as to limit the expansion of the hose in longitudinal direction upon application of a tensile stress to a value that a smaller than 2% of the hose's length in longitudinal direction, advantageously smaller than 0.5% of the hose's length, more advantageously smaller than 0.2% of the hose's length. By means of such strength member, the application of tensile stress to the signal carrier may be avoided even when the length of the signal carrier is only slightly larger than the length of the hose.

The strength member may be configured to provide a shorter connection between the first termination assembly and the second termination assembly than the hose and the signal carrier. In other words, the length of the strength member may be chosen such that when a tensile force is applied to the hose assembly, the tensile force is taken up by the strength member while the hose and the signal carrier are unstressed i.e. they are slack (to a certain limited degree). Tensile stress applied to the hose assembly can thus be efficiently absorbed by the strength member.

In an embodiment, the strength member is provided at a first end thereof with a first end fitting having an outer diameter larger than the diameter of a central portion of the strength member. The first termination assembly comprises a termination block in which the first end fitting is retained such that a tensile force applied to the strength member is transferred to the termination block of the first termination assembly.

As an example, the first end fitting may be provided by splaying out the wires of the strength member (for example when the strength member is provided by a steel cable made up of several individual wires), and providing the splayed out wires with a collet. The strength member may for example be inserted through the through hole, may be splayed out, the collet may be inserted and may be fastened in the termination block by means of a grub screw. The through hole may be a tapered through hole, and the collet may have a respective tapered outer collar. A secure and efficient attachment of the strength member to the first termination assembly may thus be achieved.

The second termination assembly and the attachment of the strength member to the second termination assembly may be configured similarly. The strength member may in particular be provided with a second end fitting that can be configured similarly or differently to the first end fitting.

In a particular embodiment, the strength member comprises a plurality of individual wires, and the strength member is attached to a termination block of the first termination assembly by clamping the individual wires between a clamping member, such as the above mentioned collet, and an interior surface of the termination block. The outer surface of the clamping member and the interior surface of the termination block may be tapered so as to provide a strong clamping force.

In other embodiments, the strength member may be provided with a first end fitting that may for example be welded or otherwise adhered to the respective end of the strength member. The strength member may extend through a through hole in the termination block of the first termination assembly into the interior space of the hose, and the diameter of the through hole may at least partially be smaller than the diameter of the first end fitting so that the first end fitting is retained in the termination block.

The first and/or second termination assembly may furthermore comprise a hose fitting that retains and seals a respective end of the hose. Such hose fitting may for example be a swaged fitting. The hose fitting may have an inner sleeve and an outer sleeve between which the end of the hose is compressed and sealed, corresponding to a compression fit.

In an embodiment, the first and/or second termination assembly may comprise a connection section by means of which it is connectable to a respective fitting or port of a subsea device, in particular to a fiber management unit (FMU), to a rear end of a subsea connector, or to a respective bulkhead opening. The connection section may for example be provided on a hose fitting forming part of the respective termination assembly. The connection section may be an MKII fitting.

The strength member may be in electrical contact with a termination block of the first and/or second termination assembly. The strength member may be in electrical contact with a hose fitting of the respective termination assembly.

In some embodiments, the signal carrier may comprise one or more electrical conductors for the transmission of an electrical signal. In other embodiments, the hose assembly does not comprise any electrical conductors for the transmission of electrical power and/or for data transmission. A hose assembly comprising electrical conductors may also benefit from the strength member disposed in the interior space of the hose, since tensile stresses in such conductor may be avoided and may be absorbed by the strength member.

In some embodiments, the strength member may be pretentioned to apply a compressive force to the hose in the longitudinal direction, for example during assembly. This way, it may be ensured that any tensile forces or tensile stresses applied to the hose assembly are applied to the strength member and do accordingly not affect the operation of the signal carrier.

In an embodiment, the hose assembly is a pressure balanced hose assembly. The hose may have a radial compliance that allows pressure compensation between a medium filling the hose and an ambient medium, for example between dielectric liquid filling the hose and surrounding seawater. The hose assembly may in particular be a pressure balanced oil filled (PBOF) hose assembly. Such configuration can allow deployment of the hose assembly at large water depths. The hose assembly may for example be configured for deployment in a water depth in excess of 2000 m, or even in excess of 3000 m.

The strength member and the signal carrier and/or the protection tube may be disposed loosely in the interior space of the hose. They may in particular not be fixed to the hose wall by some material, such as a polymer or epoxy filling of the hose. In particular, they may be moveable inside the hose.

According to a further embodiment of the invention, a subsea cable harness comprising a hose assembly according to any of the above described embodiments and configurations is provided. The subsea cable harness further comprises at least one subsea connector or at least one fiber management unit mounted to the first or second termination assembly. By such subsea cable harness, advantages similar to the ones outlined further above may be achieved.

It is to be understood that the features mentioned above and those yet to be explained below can be used not only in the respective combinations indicated, but also in other combinations or in isolation without leaving the scope of the present invention. In particular, features of the different embodiments and configurations described herein may be combined unless noted to the contrary.

### BRIEF DESCRIPTION OF THE DRAWINGS

The foregoing and other features and advantages of the invention will become further apparent from the following detailed description read in conjunction with the accompanying drawings. In the drawings, like reference numerals refer to like elements.

FIG. 1 is a schematic drawing showing a sectional side view of a hose assembly according to an embodiment.

FIG. 2 is a schematic drawing showing the encircled region of FIG. 1 in more detail.

FIG. 3 is a schematic drawing showing a sectional side view of a first end of the hose assembly of FIG. 1.

FIG. 4 is a schematic drawing showing a subsea cable harness according to an embodiment.

### DETAILED DESCRIPTION

In the following, embodiments illustrated in the accompanying drawings are described in more detail. It should be clear that the following description is only illustrative and non-restrictive. The drawings are only schematic representations, and elements in the drawings are not necessarily to scale with each other.

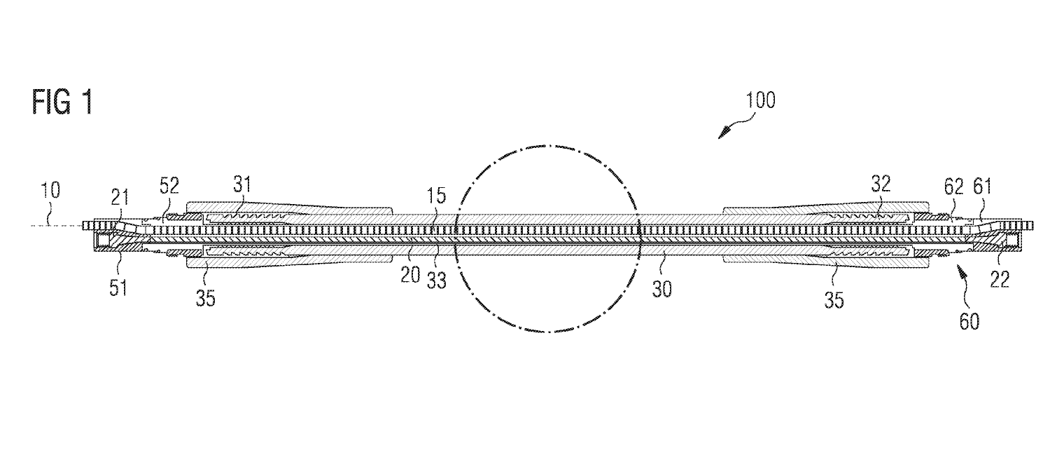

FIG. 1 illustrates a hose assembly 100 for underwater use, it may also be termed subsea hose assembly. A hose in this context is flexible tube into which other components may be placed. The hose assembly includes a hose 30 having an interior space 33 in which a signal carrier 10 is disposed. Furthermore, it includes a strength member 20, such as a reinforcing rod or bar, disposed in the interior space 33 of hose 30. In the embodiment of FIG. 1, a protection tube 15 is provided around the signal carrier 10. The hose 30 is filled with a substantially incompressible medium, in particular a dielectric liquid, and the strength member 20 is free to move within the interior space 33. Similarly, the signal carrier 10 and the protection tube 15 are free to move inside the hose 30.

Due to such movements, the strength member 20 may apply a force to the signal carrier 10, which may in turn suffer damage. Such damage to signal carrier 10 is prevented by the protection tube 15 which protects the signal carrier 10 against such forces.

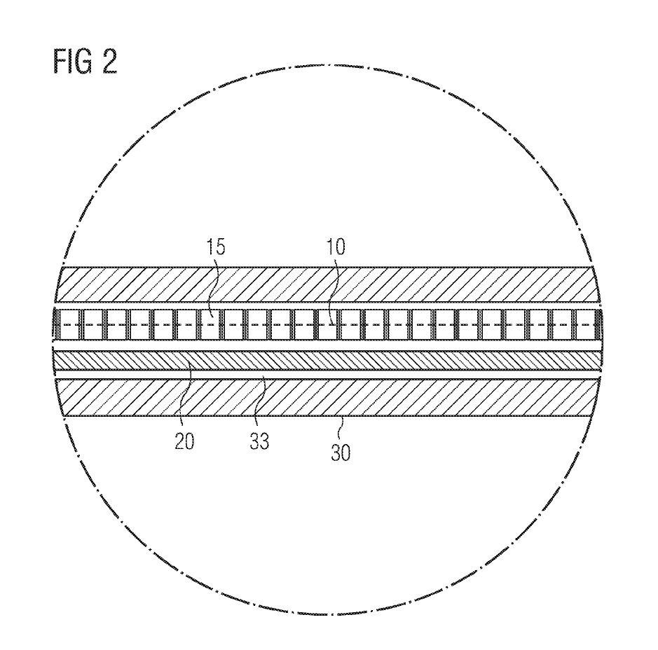

The situation is illustrated in more detail in FIG. 2 which shows that the protection tube 15 including the signal carrier 10 and the strength member 20 are disposed within the interior space 33 of hose 30. Hose 30 may be a conventional hose used in subsea cables, such as the Anguila hose conduit provided by Siemens. For example, such hose may have an outer jacket, an armor made of polyester, strain elements made of Aramid, and inner liner. The Aramid strain elements may for example be disposed between the outer jacket and the inner liner. Such hose may provide sufficient strength so it can withstand the handling by an ROV. On the other hand, such hose provides compliance in radial direction in order to allow pressure compensation of the interior space 33 to the surrounding environment. Particular, the hose 30 will accommodate volume changes of the liquid filling the hose 30 caused by pressure and/or temperature changes.

Different types of tubing are suitable to be used as protection tube 15. As an example, protection tube 15 may be a nylon tube, a polypropylene tube or a tube made of another suitable material that is capable of protecting the signal carrier 10 against the above mentioned forces.

Now turning back to FIG. 1, the hose assembly 100 comprises at a first end a first termination assembly 50 and at a second end a second termination assembly 60. The termination assemblies 50, 60 may be configured similarly. The subsequent description focuses on the first termination assembly 50, but the explanations equally apply to the second termination assembly 60.

The termination assembly 50 comprises a termination block 51 in which the strength member 20 is terminated. The termination block 51 further comprises a through hole through which signal carrier 10 is led. Furthermore, if a protection tube 15 is provided, the protection tube 15 can also be led out of the hose through the through hole in the termination block 51, as illustrated in FIG. 1.

The first termination assembly 50 furthermore comprises a hose fitting 52. The first end 31 of the hose 30 is terminated and sealed by the hose fitting 52. The hose fitting 52 may be attached to the end 31 of hose 30 by swaging, it may be a swaged fitting. In particular, the hose fitting 52 may comprise an outer sleeve and an inner sleeve that are pressed together (e.g. by a swaging tool) to clamp the end 31 of hose 30 there between. As can be seen in FIG. 1, the sleeves are provided with protrusions to retain the hose 30 firmly in the hose fitting 52.

The hose fitting 52 has a through hole through which the strength member 20 extends towards the terminating block 51. Further, the hose fitting 52 has a through hole through which the signal carrier 10 and the protection hose 15 extend to the terminating block 51.

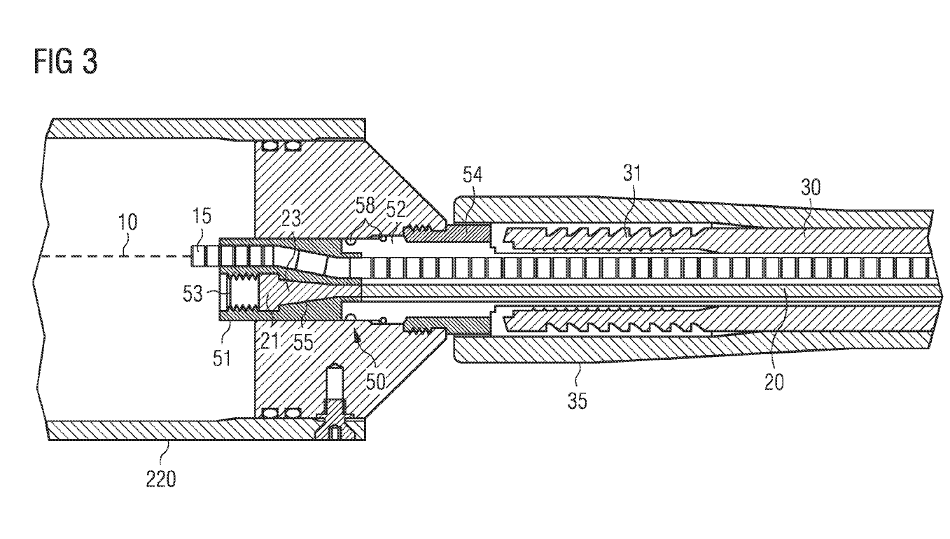

This is shown in more detail in FIG. 3. In the example of FIG. 3, the first termination assembly 50 is mounted to a subsea device 220, such as a fiber management unit. The termination block 51 is inserted into an opening in the subsea device 220, it can be slid into such opening. The hose fitting 52 comprises a connection section in form of nut 54 by means of which the hose fitting 52 is mounted in the opening of the subsea device 220. Two seals 58 on the hose fitting 52 provide sealing and a double barrier against ingress of seawater.

The strength member 20 is provided at each end with an end fitting 21, 22. The end fitting 21 is retained in the termination block 51. The end fitting 21 can be provided in different forms. In the example of FIG. 3, the end fitting 21 is provided by inserting the strength member 20 through a through hole 55 in the termination block 51. The through hole 55 has a tapered shape. Individual wires of the strength member 20 are then splayed out and a collet is inserted into the through hole 55. The collet may have a shape that corresponds to the tapered shape of the through hole 55 and may clamp the individual wires in the through hole. In FIG. 3, the collet is indicated by reference numeral 23, but it is not visible since it is covered by the respective wires. Furthermore, a former or crown can be provided above the collet. The first end fitting 21 is held in place by a set screw or grub screw 53. By tightening the grub screw 53, a compressive force can be applied and an effective clamping of the wires of the strength member 20 in the through hole 55 can be achieved.

In other embodiments, the first end termination 21 can be configured differently. As an example, a fitting having a larger diameter than the strength member 20 may be welded to the end of the strength member 20 and may be retained in a respective through hole which may be tapered or not.

The second end fitting 22 on the other end of the strength member 20 may be configured similarly.

As can be seen in detail in FIG. 3, the signal carrier 10, as well as the protection tube 15 are led through the hose fitting 52 and the termination block 51 into an interior space of the subsea device 220. The termination assembly 50 may be compatible with a range of different subsea devices and connectors, and it may as well be fitted into a rear section of a subsea connector, in particular a wet-mateable connector. In such configurations, a penetrator may furthermore be provided for the data carrier 10 for leading the data carrier 10 into the connector, so that the volume of the cable and the inner volume of the connector can be kept separate.

In an embodiment, the strength member 20 is a steel cable. Such steel cable may be composed of a plurality of individual steel wires. Such steel cable may have a thickness of between about 10 mm and about 1 mm, it may for example be 3 mm thick. To such steel cable, substantial tensile forces can be applied without significant stretching of the steel cable. The strength member 20 may in particular be configured to stretch less than 1%, advantageously less than 0.5%, more advantageously less than 0.2% of its length when a tensile force is applied, for example when the hose assembly is accidentally caught by an ROV or the like.

Turning back to FIG. 1, the hose 30, the signal carrier 10 and the strength member 20 are now configured such that any tensile stress applied to the hose assembly 100 is substantially transferred to the strength member 20 and absorbed by the strength member 20. Accordingly, if for example during installation, a pulling force is applied to one end of the hose assembly 100, e.g. by means of an ROV, such pulling force is applied to the strength member 20, so that the hose does not stretch and the signal carrier 10 does not experience tensile stress. It should be clear that the signal carrier 10 is generally affixed at some place in the subsea device or connector to which the hose assembly 100 is mounted, so that any expansion of the hose assembly 100 in the longitudinal direction would lead to a tensile stress being applied to the signal carrier 10. Accordingly, since in the embodiment of FIG. 1, such expansion is reduced significantly by the strength member 20, it is not necessary to provide a complex fiber management system that is capable of counteracting such expansion/contraction of the hose assembly.

As an example, the length of the strength member 20 may be slightly reduced so that it slightly compresses the hose 30 when mounted in the hose assembly 100. In other words, the strength member 20 may be pretensioned slightly. When both ends of the hose assembly 100 are pulled apart, the force is then applied almost completely to the strength member 20, while the hose 30 and the signal carrier 10 still have a certain degree of slack.

Other examples in which tensile stress may be applied to the hose assembly 100 is when a part of an ROV is accidentally caught by the hose 30, thus applying significant tensile forces to the hose assembly 30. Another example is contraction and expansion experienced by the hose 30 due to volume changes of the medium filling the interior space 33. As an example, when the medium expands, the hose 30 may experience contraction, and when the liquid cools, it may experience expansion. By providing a respective pre-tensioning of the strength member 20, such compression and expansion does not result in a tensile stress being applied to the signal carrier 10.

The signal carrier 10 may include at least one optical fiber. Preferably, the signal carrier 10 is a fiber ribbon. In other embodiments, the signal carrier 10 may additionally or alternatively include one or more electrical conductors for data transmission. In such configurations, the protection tube 15 may not be needed. In another embodiment, only one or more optical fibers, in particular a fiber ribbon, are provided as signal carrier 10.

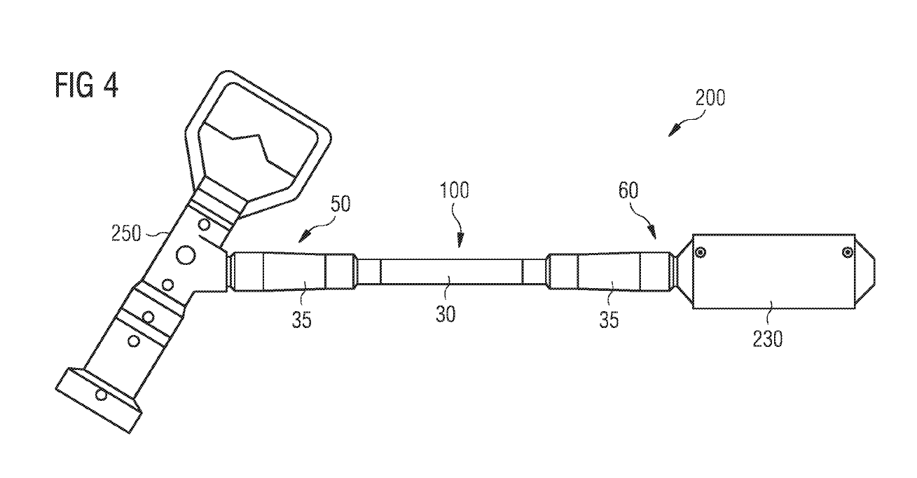

FIG. 4 is a schematic drawing showing a subsea cable harness 200 according to an embodiment. The subsea cable harness 200 includes a hose assembly 100 that can have any of the above described configurations. The respective first and second termination assemblies 50, 60 are covered by respective boots 35. Boots 35 can be rubber boots or can be made of another plastic or polymer material. In the example of FIG. 4, the first termination assembly 50 is mounted to a rear portion of a subsea wet-mateable connector 250. The second termination assembly 60 is mounted to a subsea device in form of a fiber termination unit 230. The fiber termination unit 230 may for example comprise splices of the optical fibers of a fiber ribbon constituting the signal carrier 10. Accordingly, when a ROV applies a pulling force to the subsea connector 250 that leads to a tensile force in the hose assembly 100, the strength member 20 bears the load that is applied in the longitudinal direction of the hose 30. Tensile stress in the signal carrier 10 can thus be avoided.

Several advantages may be achieved with embodiments of the present invention. Provision of the strength member 20 is possible as a retrofit for existing subsea cables, or as part of the construction process using conventional hose and conventional signal carriers. Since the strength member 20 is provided within the hose 30, the external shape or appearance of the hose assembly 100 is not changed. Also, no additional external snag points at which for example a part of subsea equipment or an ROV component may be caught are added to the hose assembly 100. Also, since the strength member 20 is provided relatively close to the central axis of the hose 30, the load distribution may be improved compared to configurations in which an external strength member is provided that is located further away from the central axis. By providing the above outlined configuration of the strength member termination internal to the hose assembly, the strength member 20 may be integrated in current assembly procedures for hose assemblies without any significant modification or requalification, thus leading to a cost efficient solution. Also, and as mentioned above, no additional management system for the signal carrier 10 that counteracts a possible expansion and contraction of the hose 30 is required, whereby significant costs may be avoided. Also, the overall space required by the strength member 20 and its terminations is relatively small, so that a compact solution can be achieved, which from an outside view, is substantially no different from a conventional subsea cable employing an oil filled hose.

While specific embodiments are disclosed herein, various changes and modifications can be made without departing from the scope of the invention. The embodiments described herein are to be considered in all respects as illustrative at non-restrictive, and any changes coming within the meaning and a equivalency range of the appended claims are intended to be embraced therein.

1. A hose assembly for use underwater or in a wet or severe environment, comprising:
a hose having an interior space and extending in a longitudinal direction;
a first termination assembly terminating the hose at a first end and a second termination assembly terminating the hose at a second end;
a signal carrier disposed in the interior space of the hose and extending between the first and second termination assemblies; and
a strength member disposed in the interior space of the hose;
wherein the strength member is mounted to the first termination assembly and to the second termination assembly and extends between the first termination assembly and the second termination assembly through the interior space of the hose, the strength member being configured to at least partly bear tensile stress applied to the hose assembly.

2. The hose assembly according to claim 1,
wherein the strength member comprises a metal cable, a steel cable, or a strand of carbon composite material.

3. The hose assembly according to claim 1,
wherein the signal carrier comprises at least one optical fiber, an optical fiber strand, or an optical fiber ribbon.

4. The hose assembly according to claim 1,
wherein the interior space of the hose is filled with a substantially incompressible medium, a liquid, a gel, a dielectric liquid, an oil, or a silicone oil.

5. The hose assembly according to claim 1, further comprising:
a protection tube disposed in the interior space of the hose, wherein the signal carrier extends inside the protection tube.

6. The hose assembly to claim 5,
wherein the protection tube has at least one opening, or plural openings, to allow a flow of a medium that is present in the interior space of the hose into and out of the protection tube.

7. The hose assembly according to claim 5,
wherein the first and/or second termination assembly comprises a through hole through which the protection tube and the signal carrier extend.

8. The hose assembly according to claim 1,
wherein the strength member is configured to limit the expansion of the hose in a longitudinal direction upon application of a tensile stress to a value that is smaller than 2% of the hose's length in the longitudinal direction.

9. The hose assembly according to claim 1,
wherein at a first end, the strength member is provided with a first end fitting having an outer diameter larger than the diameter of the strength member, wherein the first termination assembly comprises a termination block in which the first end fitting is retained such that a tensile force applied to the strength member is transferred to the termination block of the first termination assembly.

10. The hose assembly according to claim 9,
wherein the termination block of the first termination assembly has a through hole leading through the termination block into the interior space of the hose, wherein the strength member extends through the through-hole into the interior space of the hose, wherein the diameter of the through hole is at least partly smaller than the diameter of the first end fitting so that the first end fitting is retained in the termination block.

11. The hose assembly according to claim 1,
wherein the strength member comprises a plurality of individual wires, and wherein the strength member is attached to a termination block of the first termination assembly by clamping the individual wires between a clamping member an interior surface of the termination block.

12. The hose assembly according to claim 1,
wherein the first and/or second termination assembly comprises a connection section by means of which it is connectable to a respective fitting of a subsea device, to a rear end of a subsea connector, or to a respective bulkhead fitting.

13. The hose assembly according to claim 1,
wherein the hose assembly is a pressure balanced oil filled hose assembly, wherein the hose has a radial compliance that allows pressure compensation between a medium filling the hose and an ambient medium.

14. The hose assembly according to claim 1,
wherein the strength member and/or a protection tube are disposed loosely in the interior space of the hose.

15. A subsea cable harness comprising:
a hose assembly according to claim 1, and
at least one subsea connector and/or fiber management unit mounted to the first or second termination assembly.

16. The hose assembly according to claim 1,
wherein the strength member is configured to limit the expansion of the hose in a longitudinal direction upon application of a tensile stress to a value that is smaller than 0.5% of the hose's length in the longitudinal direction.

17. The hose assembly according to claim 1,
wherein the strength member is configured to limit the expansion of the hose in a longitudinal direction upon application of a tensile stress to a value that is smaller than 0.2% of the hose's length in the longitudinal direction.
